(19) United States
(12) Patent Application Publication
(10) Pub. No.: US 2005/0236105 A1
(43) Pub. Date: Oct. 27, 2005

(54) Apparatus and method for manufacturing laminated substrate

(75) Inventors: Joji Hasegawa, Kasugai (JP); Takuya Ohno, Kasugai (JP); Akiyoshi Ito, Kasugai (JP); Tetsuji Kadowaki, Kasugai (JP); Takanori Muramoto, Kasugai (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 10/951,804

(22) Filed: Sep. 29, 2004

(30) Foreign Application Priority Data
Apr. 26, 2004 (JP) 2004-130045

(51) Int. Cl. B32B 31/00

(52) U.S. Cl. 156/312; 156/581

(57) ABSTRACT

A laminated substrate manufacturing apparatus that seals an inner side of a seal frame into which liquid crystal is filled while reducing manufacturing deficiencies of laminated substrates. The substrate includes a first holding plate and a second holding plate for holding two substrates. A seal pressing device arranged on one of the first and second holding plates presses a seal formed between the substrates.

### CROSS-REFERENCE TO RELATED APPLICATIONS

This application is based upon and claims the benefit of priority from prior Japanese Patent Application No. 2004-130045, filed on Apr. 26, 2004, the entire contents of which are incorporated herein by reference.

### BACKGROUND OF THE INVENTION

The present invention relates to an apparatus and a method for manufacturing a laminated substrate (panel) by laminating two substrates.

Recently, with plane panel displays such as liquid crystal displays (LCDs) becoming larger and thinner, the demand for reduction in the cost of manufacturing such displays is increasing. To meet such demand, an apparatus for laminating two substrates is also required for application in such enlargement while improving productivity.

A liquid crystal panel is manufactured in the following manner. First, an array substrate (TFT substrate), in which a plurality of TFTs (thin film transistors) are formed in a matrix, and a color filter substrate (CF substrate), in which color filters (red, green, blue) and a light shielding film are formed, are arranged facing each other with an extremely narrow gap (approximately a few micrometers) in between. Liquid crystal is filled in the gap between the two substrates. The light shielding film is used to obtain high contrast or to shield the TFTs and prevent the occurrence of light leakage current. The TFT substrate and the CF substrate are laminated to each other with a sealing material (adhesive) that contains, for example, a thermosetting resin.

In the conventional method for manufacturing the liquid crystal panel, a liquid crystal-dropping process is performed when filling the liquid crystal between two glass substrates. More specifically, a frame of the sealing material is formed on one side of the TFT substrate along the edges of the substrate. A certain amount of liquid crystal is dropped onto a region defined in the frame of the sealing material. Subsequently, the TFT substrate and the CF substrate are laminated to each other in a vacuum environment to seal the liquid crystal between the substrates. In a typical liquid crystal display panel, the distance between the two substrates (cell gap) after filling the liquid crystal is extremely narrow and is, for example, 5 μm.

When laminating the substrates to each other, the two substrates must be held parallel to each other with high accuracy so that the sealing material on one of the substrates is entirely in substantial contact with the two substrates.

After laminating the two substrates to each other in a processing chamber under a vacuum environment, the pressure of the processing chamber is returned to atmospheric pressure, and the sealing material is solidified. In this state, distortion of the substrates occur at the inner region of the sealing material frame (i.e., the region in which liquid crystal is filled, referred to as vacuum pressure side) and the outer region of the sealing material frame (referred to as atmospheric pressure side). This is because force pressing the two substrates toward each other does not act on the substrates in the outer region. The distortion of the substrates results in the cell gap becoming uneven, which, in turn, results in deficient lamination.

Japanese Laid-Open Patent Publication No. 11-326922 describes a first prior art example that makes the cell gap uniform. In the first prior art example, a first seal is surrounded by a second seal. A vacuum region is defined between the first and second seals.

Japanese Laid-Open Patent Publication No. 10-31220 describes a second prior art example that makes the cell gap uniform. In the second prior art example, a spacer for adjusting the cell gap is included only in a seal. The seal is formed on a substrate in an annular form. An annular pressing member is pressed against a seal portion to which the annular seal is applied, and the liquid crystal display region surrounded by the seal portion is pressed by gas pressure.

### SUMMARY OF THE INVENTION

The cell gap also becomes uneven and causes deficient lamination when the thickness of the substrates and the seal is uneven. The uneven thickness of the substrates and the seal decreases the parallelism between the laminated surfaces of the substrates. If the substrates are laminated to each other in such a state, in the first prior art example, the inner side of the frame of the second seal cannot be air-tightly sealed from the outer side of the second seal. This may result in deficient lamination.

Further, the second prior art example is applicable only when laminating substrates by including the cell gap adjustment spacer only in the seal. Thus, the second prior art example cannot be applied to an apparatus that presses laminated substrates having a display region in which a spacer is included.

One aspect of the present invention is an apparatus for manufacturing a laminated substrate by pressing two substrates towards each other. One of the two substrates has a seal formed thereon. The apparatus includes a processing chamber. A first holding plate and a second holding plate are arranged facing towards each other in the processing chamber to respectively hold one of the two substrates. A projection is arranged on at least one of the first and second holding plates at a portion corresponding to the seal to press the seal.

A further aspect of the present invention is a method for manufacturing a laminated substrate. The method includes holding an upper substrate and a lower substrate with an upper holding plate and a lower holding plate facing towards each other in a processing chamber, forming a seal on the lower substrate, dropping liquid crystal into an inner region of the seal, and pressing the upper substrate and the lower substrate between the upper holding plate and the lower holding plate. The pressing includes pre-pressing a portion of the lower substrate that corresponds to the seal with gas pressure, and pressing the upper substrate and the lower substrate with the upper holding plate and the lower holding plate subsequent to said pre-pressing.

Another aspect of the present invention is an apparatus for manufacturing a laminated substrate from two substrates that are adhered to each other by a seal. The apparatus includes a processing chamber. A first holding plate and a second holding plate are arranged facing towards each other in the processing chamber to press the two substrates that are adhered to each other by a seal. A seal pressing device is arranged on at least one of the first and second holding plates to press the seal.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic cross-sectional diagram of a laminated substrate manufacturing apparatus according to a first embodiment of the present invention;

FIG. 2 is a plan view showing a seal pressing device of the first embodiment;

FIGS. 3 and 4 are partial cross-sectional diagrams of the seal pressing device of the first embodiment;

FIG. 5 is a plan view showing a seal pressing device according to a second embodiment of the present invention;

FIG. 6 is a partial cross-sectional view showing the seal pressing device of the second embodiment;

FIGS. 7 and 8 are partial cross-sectional diagrams of a seal pressing device according to a third embodiment of the present invention;

FIGS. 9 and 10 are partial cross-sectional diagrams of a seal pressing device according to a fourth embodiment of the present invention;

FIG. 11 is a plan view showing a seal pressing device according to a fifth embodiment of the present invention;

FIG. 12 is a partial cross-sectional diagram of the seal pressing device of the fifth embodiment;

FIG. 13 is a plan view of a seal pressing device according to a sixth embodiment of the present invention;

FIG. 14 is a plan view of a seal pressing device according to a seventh embodiment of the present invention;

FIG. 15 is a plan view of a seal pressing device according to an eighth embodiment of the present invention; and

FIG. 16 is a plan view of a seal pressing device according to a ninth embodiment of the present invention.

### DETAILED DESCRIPTION OF THE PREFERRED EMBODIMENTS

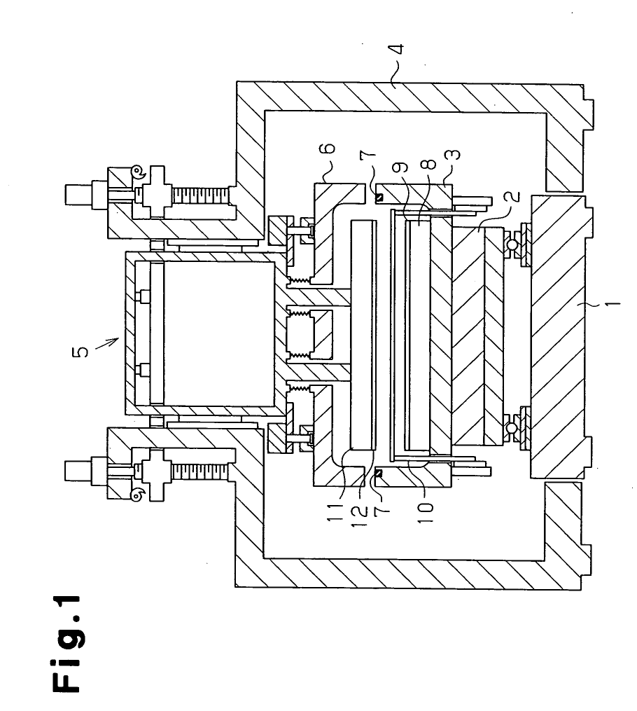

A laminated substrate manufacturing apparatus according to a first embodiment of the present invention will now be discussed with reference to FIG. 1. A positioning stage 2 is arranged on a base 1. A lower shell 3 is supported on the positioning stage 2. A support frame 4 is fixed to the base plate 1. An upper portion of the support frame 4 supports a driving mechanism 5. An upper shell 6 is arranged above the lower shell 3. The driving mechanism 5 lifts and lowers the upper shell 6. When the upper shell 6 is lowered so that its bottom end contacts the top end of the lower shell 3, a closed or sealed processing chamber (vacuum chamber) is defined in the upper shell 6 and the lower shell 3.

A gasket 7 is attached to the surface of the top end of the lower shell 3 that comes into contact with the bottom end of the upper shell 6. The gasket 7 keeps the vacuum chamber hermetic. A lower holding plate 9 is arranged on the upper surface of the lower shell 3 with a lower mass (surface plate) 8 arranged between the lower shell 3 and the lower holding plate 9. The lower holding plate 9 includes an electrostatic chuck for electrostatically holding a lower substrate W2 (see FIG. 3). The operation of the electrostatic chuck is controlled by a controller (not shown). A lower substrate holder 10 is supported by the lower shell 3. The lower substrate holder 10 is lowered and raised by a driving device (not shown).

An upper mass (surface plate) 11, which is arranged above the lower holding plate 9, is raised and lowered by the driving mechanism 5. An upper holding plate 12 is attached to the lower surface of the upper mass 11. Accordingly, the upper holding plate 12 is integrally lowered and raised with the upper mass 11.

The upper holding plate 12 includes a vacuum chuck and an electrostatic chuck to attract an upper substrate W1 (see FIG. 3). The vacuum chuck and the electromagnetic chuck are each controlled by a controller. The upper substrate W1 (TFT substrate), which is held by the upper holding plate 12, and the lower substrate W2 (CF substrate), which is held by the lower holding plate 9, are laminated to each other in the processing chamber in a vacuum state.

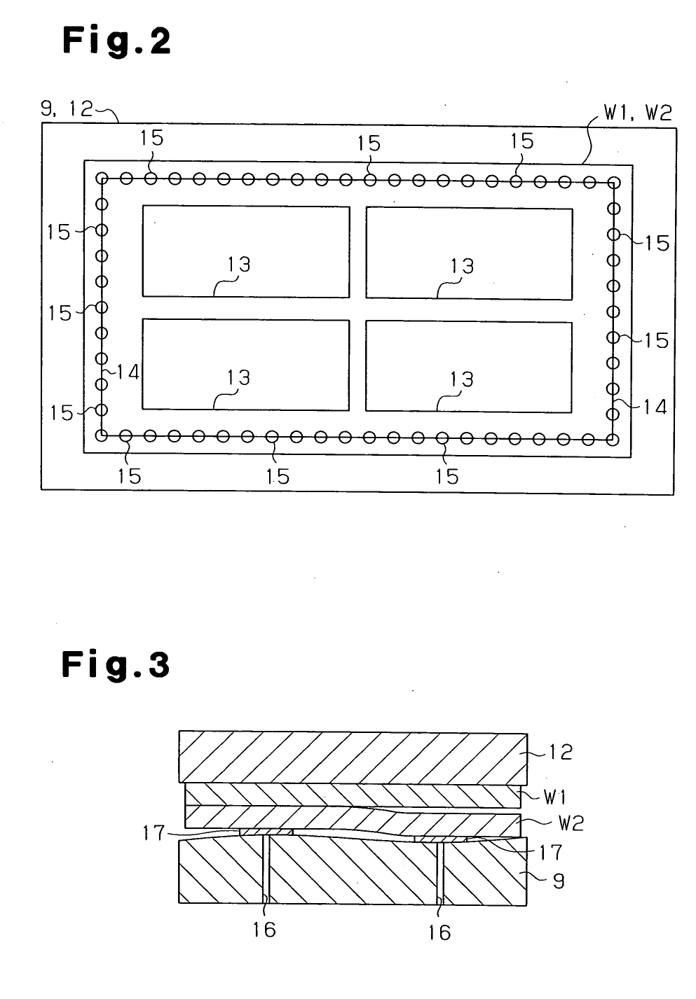

In the first embodiment, the upper substrate W1 and the lower substrate W2 are relatively large substrates so that a plurality of liquid crystal substrates can be formed from the upper and lower substrates W1 and W2. The thickness of the substrates W1 and W2 is approximately 0.4 mm to 1.1 mm. As shown in FIG. 2, a plurality of main seals 13 are formed on the upper substrate W1 or the lower substrate W2 so as to surround the display region of each liquid crystal substrate. Further, a dummy seal 14 is formed on the peripheral portion of the upper substrate W1 or the lower substrate W2. A plurality of equally spaced seal pressing devices 15 are arranged along the dummy seal 14 to ensure the filling of liquid crystal. The seal pressing devices 15 press portions corresponding to the dummy seal 14 formed on the upper substrate W1 or the lower substrate W2.

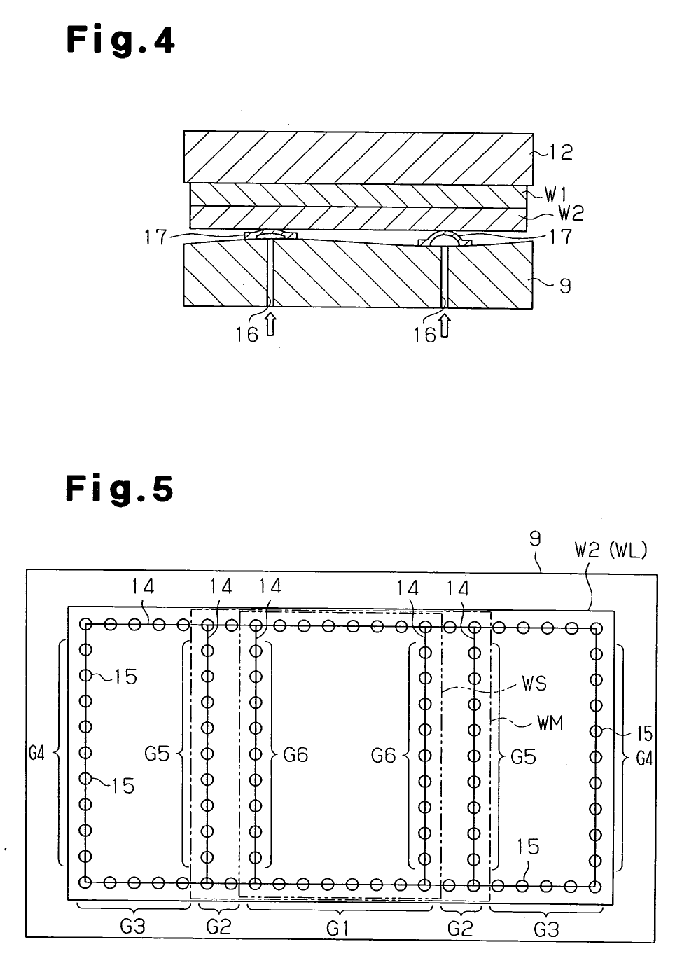

The seal pressing device 15 will now be described in detail with reference to FIGS. 3 and 4. A plurality of gas supply passages 16 are formed in the lower holding plate 9 along the dummy seal 14. The gas supply passages 16 open at the upper surface of the lower holding plate 9. The opening of each gas supply passage 16 is covered by a sheet 17.

The sheet 17 is a thin film made of metal, such as stainless steel, or a synthetic resin, such as synthetic rubber, and has a rectangular shape. When the sheet 17 is a thin film made of metal or a synthetic resin, the thickness of the sheet 17 is normally 50 to 200 μm. When the sheet 17 is a thin film made of synthetic rubber, the thickness of the sheet 17 is normally 100 to 500 μm. It is preferred that the coefficient of static friction of the sheet 17 be greater than that of the lower holding plate 9. In the preferred embodiment, the coefficient of static friction of each sheet 17 is 0.2 to 0.3, and the interval of the sheets 17 is 15 to 30 mm.

The peripheral portion of each sheet 17 is adhered to the lower holding plate 9 by an adhesive. Gas, such as nitrogen, is supplied into the gas supply passages 16 from a gas supplying apparatus (not shown), which is controlled by the controller of the laminated substrate manufacturing apparatus. When gas is discharged from each gas supply passage 16 toward the corresponding sheet 17, the sheet 17 is elastically, resiliently or reversibly deformed so that its central portion expands upward.

The operation of the laminated surface manufacturing apparatus provided with the seal pressing devices 15 will now be discussed.

As shown in FIG. 3, the upper substrate W1 is attracted to the upper holding plate 12, and the lower substrate W2 is attracted to the lower holding plate 9. In a state in which the pressure of the processing chamber is atmospheric, liquid crystal including a spacer for adjusting the cell gas is dropped onto the inner side of each main seal 13 on the lower substrate W2. The processing chamber is then depressurized, and the two substrates W1 and W2 are aligned with each other. The upper holding plate 12 is lowered to press the upper substrate W1 and the lower substrate W2 between the upper holding plate 12 and the lower holding plate 9 and laminate the substrates W1 and W2 to each other.

When laminating, gas is supplied to the gas supply passages 16 to elevate the central portion of each sheet 17 and push the lower substrate W2 upward. This presses the upper substrate W1 and the lower substrate W2 at portions corresponding to the dummy seal 14 more strongly than other portions to ensure that the dummy seal 14 is squeezed between the two substrates W1 and W2. The inner side of the dummy seal 14 is sealed from the outer side of the dummy seal 14. This keeps the region between the dummy seal 14 and the main seals 13 in vacuum. In this state, liquid crystal is filled in the inner side of each main seal 13. In the inner side of each main seal 13, a spacer included in the liquid crystal keeps the distance between the substrates W1 and W2 constant.

Subsequently, the processing chamber is returned to atmospheric pressure. The difference of the pressure between the two substrates W1 and W2 from atmospheric pressure compresses the two substrates W1 and W2. This narrows the distance between the two substrates W1 and W2 to a predetermined cell thickness.

The first embodiment has the advantages described below.

(1) The seal pressing devices 15 presses portions at which the dummy seal 14 is formed more strongly than other portions to ensure that the dummy seal 14 is squeezed between the two substrates W1 and W2. The inner side of the dummy seal 14 is sealed from the outer side of the dummy seal 14. This keeps the region between the dummy seal 14 and the main seals 13 in vacuum. As a result, the substrates W1 and W2 are prevented from being distorted. This reduces deficient lamination of the substrates W1 and W2.

(2) Enlargement of the substrates W1 and W2 decreases the flatness of the pressing surface of the lower holding plate 9. For example, for the surface of the lower holding plate 9 corresponding to a substrate size of 1200 mm×1300 mm, distortion occurs within a range of ±5 μm. For the surface of the lower holding plate 9 corresponding to a larger substrate size of 2000 mm×2300 mm, distortion occurs within a wider range of ±20 μm. In the first embodiment, as shown in FIG. 4, gas is used to elevate each sheet 17. This absorbs the influence of surface distortion of the lower holding plate 9 when the dummy seal 14 is pressed.

(3). The two substrates W1 and W2 are aligned with each other without contacting each other. Then, the seal pressing devices 15 presses the two substrates W1 and W2. This improves the lamination position accuracy of the two substrates W1 and W2. More specifically, when only lowering the upper mass 11 to press the two substrates W1 and W2, the upper mass 11, which normally has a weight of 2000 to 4000 kg, must be accurately lowered so that pressure (load) is not applied to the two substrates W1 and W2 in the horizontal direction. In the first embodiment, the seal pressing devices 15 apply pressure to the portions of the two substrates W1 and W2 that correspond to the dummy seal 14 before the upper mass 11 presses the two substrates W1 and W2. This improves the lamination accuracy without having to lower the upper mass 11 with high accuracy. Since the upper mass 11 does not have to be lowered and raised with high accuracy, the lifting device of the upper mass 11 may be simplified.

(4) The sheets 17 are made from a material having a relatively high friction coefficient. This prevents the lower substrate W2 from being displaced relative to the lower holding plate 9 during lamination. The lower substrate W2 must be prevented from being displaced relative to the lower holding plate 9 when the two substrates W1 and W2 are aligned with each other in a state in which the dummy seal 14, the main seals 13, and the liquid crystal are in contact with the substrates W1 and W2. The sheets 17 function to prevent such displacement. This ensures the pressing of the portions corresponding to the dummy seal 14.

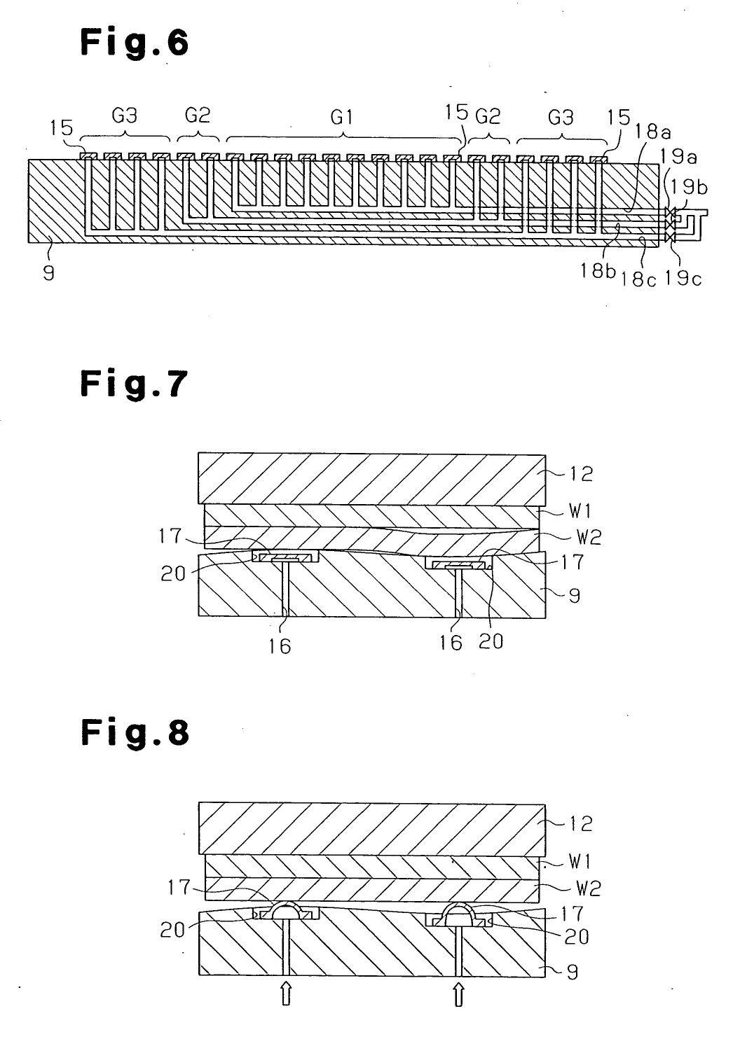

A second embodiment of the present invention will now be described with reference to FIGS. 5 and 6. In the second embodiment, the lower holding plate is provided with seal pressing devices that may be used for substrates having different sizes.

Referring to FIG. 5, the lower holding plate 9 includes seal pressing devices 15 corresponding to three substrate sizes WL, WM, and WS of the upper substrate W1 and the lower substrate W2. The structure of each seal pressing device 15 is the same as that of the first embodiment.

Seal pressing devices 15 are arranged along the peripheral portion of the lower holding plate 9. The seal pressing devices 15 arranged parallel to the long sides at the middle part of the lower holding plate 9 define a first group G1. The seal pressing devices 15 arranged on each side of the first group G1 define a second group G2. The seal pressing devices 15 arranged outward from each second group G2 define a third group G3. Referring to FIG. 6, the seal pressing devices 15 of the first group G1 are supplied with gas through gas supply passages 18a, the seal pressing devices 15 of the second group G2 are supplied with gas through gas supply passages 18b, and the seal pressing devices 15 of the third group G3 are supplied with gas through gas supply passages 18c. The gas supply passages 18a, 18b, and 18c, which are independent from one another, are opened and closed by valves 19a, 19b, and 19c, respectively.

The seal pressing devices 15 arranged parallel to the short sides of the lower holding plate 9 define a fourth group G4. Seal pressing devices 15 are also arranged within the peripheral portion of the lower holding plate 9 parallel to the short sides. Those arranged inward from each fourth group G4 define a fifth group G5, and those arranged further inward from each fifth group G5 define a sixth group G6. The seal pressing devices 15 of the fourth to sixth groups G4 to G6 are also respectively connected to gas supply passages that are independent from each other.

The first, second, third, and fourth groups G1, G2, G3, and G4 are used in correspondence with the dummy seal 14 for the largest substrate size WL. The first, second, and fifth groups G1, G2, and G5 are used in correspondence with the dummy seal 14 for the middle substrate size WM. The first and sixth groups G1 and G6 are used in correspondence with the dummy seal 14 for the smallest substrate size WM.

With such a structure, gas is supplied to the seal pressing devices 15 of the first, second, third, and fourth groups G1, G2, G3, and G4 when laminating substrates of substrate size WL. Gas is supplied to the seal pressing devices 15 of the first, second, and fifth groups G1, G2, and G5 when laminating substrates of substrate size WM. Gas is supplied to the seal pressing devices 15 of the first and sixth groups G1 and G6 when laminating substrates of substrate size WS.

In addition to the advantages of the first embodiment, the second embodiment has the following advantage.

(1) The structure of the second embodiment ensures the pressing of portions corresponding to the dummy seal 14 for the substrates W1 and W2 of different sizes WL, WM, and WS.

A third embodiment of the present invention will now be described with reference to FIGS. 7 and 8. Except for the point that the lower holding plate 9 includes accommodation recesses 20 for accommodating the sheets 17, the structure of the third embodiment is the same as that of the first embodiment.

Each accommodation recess 20 is formed in the upper surface of the lower holding plate 9. A sheet 17 is adhered to the bottom surface of the accommodation recess 20. When gas is not supplied from the corresponding gas supply passage 16, the sheet 17 is not projected from the upper surface of the lower holding plate 9. When gas is supplied from the corresponding gas supply passage 16, the sheet 17 is projected from the accommodation recess 20 to push the lower substrate W2 upwards, as shown in FIG. 8.

Due to such structure, when aligning the two substrates W1 and W2 to each other, the sheets 17 do not push the lower substrate W2 and do not produce friction between the substrates W1 and W2. Accordingly, the two substrates W1 and W2 are smoothly aligned with each other.

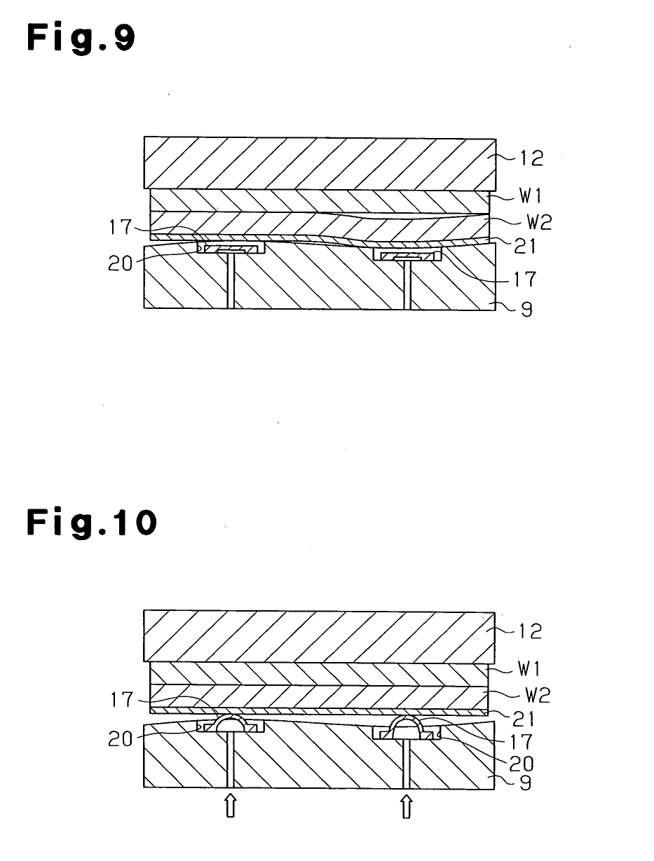

A fourth embodiment of the present invention will now be described with reference to FIGS. 9 and 10. In the fourth embodiment, a cushion 21 is added to the structure of the third embodiment. The cushion 21, which is arranged between the lower holding plate 9 and the lower substrate W2, extends along the entire surface of the lower substrate W2. Further, the cushion 21 is a porous sheet made of synthetic resin or synthetic rubber and has a thickness of 100 to 500 μm. The employment of a porous sheet as the cushion 21 enables the lower substrate W2 to be vacuum-attracted to the lower holding plate 9 through the cushion 21.

Accordingly, in addition to the advantages of the third embodiment, the fourth embodiment has the advantages described below.

(1) When applying pressure to the lower substrate W2 with the sheets 17, the arrangement of the cushion 21 between the sheets 17 and the lower substrate W2 prevents damage from being inflicted on the lower substrate W2.

(2) The cushion 21 is made of a material having a high friction coefficient. This prevents displacement of the lower substrate W2 relative to the lower holding plate 9 during lamination.

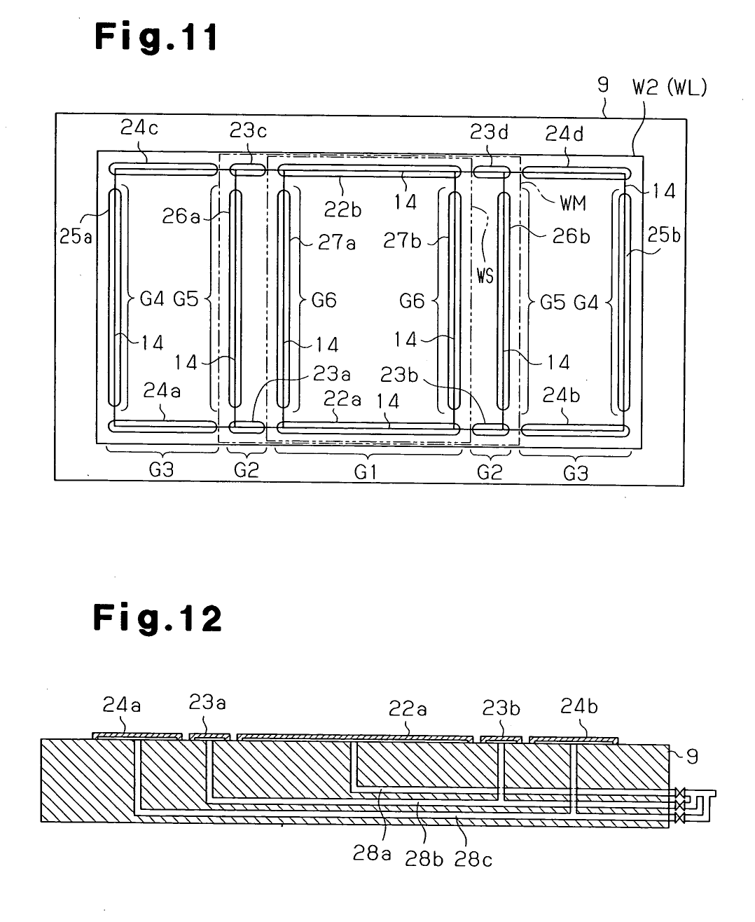

A fifth embodiment according to the present invention will now be described with reference to FIGS. 11 and 12. In the fifth embodiment, the plurality of sheets used in each group of the seal pressing devices of the second embodiment are replaced by a single sheet.

More specifically, the first groups G1 are respectively formed by sheets 22a and 22b. The second groups G2 are respectively formed by sheets 23a, 23b, 23c, and 23d. Further, the third groups G3 are respectively formed by sheets 24a, 24b, 24c, and 24d.

In the same manner, the fourth groups G4 are respectively formed by sheets 25a and 25b. The fifth groups G5 are respectively formed by sheets 26a and 26b. The sixth groups G6 are respectively formed by sheets 27a and 27b.

Referring to FIG. 12, parallel to the long sides of the lower holding plate 9, the sheet 22a is supplied with gas from a gas supply passage 28a. The sheets 23a and 23b are supplied with gas from a gas supply passage 28b. The sheets 24a and 24b are supplied with gas from a gas supply passage 28c. The gas supply passages 28a to 28c are independent from one another. The sheets 25a, 25b and 27a, 27b that are parallel to the short sides of the lower holding plate 9 are supplied with gas in the same manner.

The fifth embodiment has the same advantages as the second embodiment. In addition, the fifth embodiment has fewer gas supply passages and sheets than the second embodiment. Thus, the fifth embodiment simplifies the structure of the seal pressing devices and reduces costs.

Each sheet may be accommodated in an accommodation recess such as that used in the third embodiment. A cushion such as that used in the fourth embodiment may also be arranged between the lower substrate W2 and the sheets.

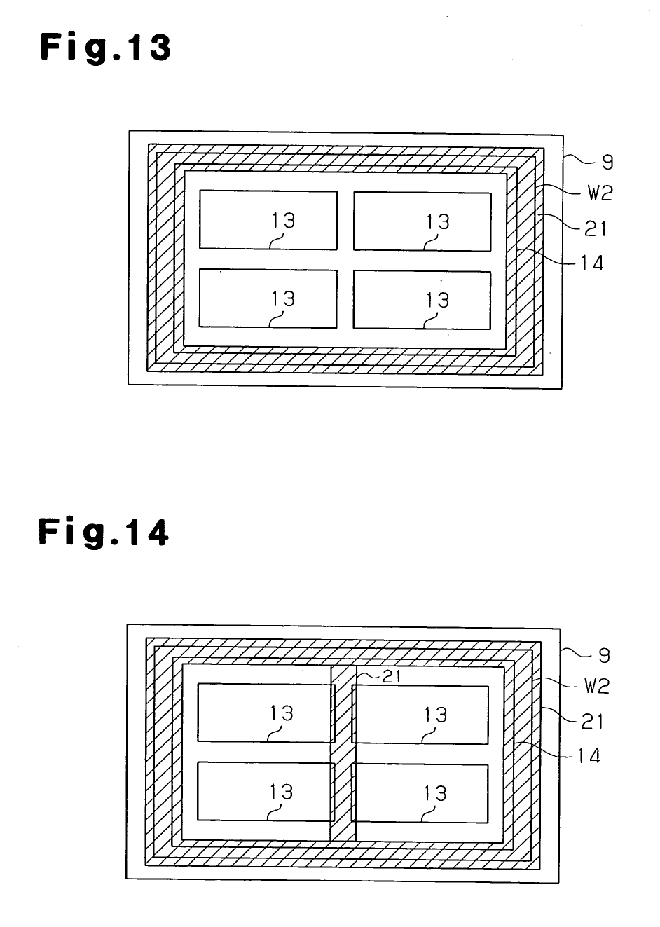

A sixth embodiment of the present invention will now be described with reference to FIG. 13. In the sixth embodiment, a frame-shaped cushion 21 is arranged near the dummy seal 14 between the lower holding plate 9 and the lower substrate W2.

When laminating the substrates W1 and W2, the cushion 21 functions as a projection that presses the dummy seal 14. Thus, in the same manner as the seal pressing devices of the above embodiments, the cushion 21 reduces deficient lamination.

A seventh embodiment of the present invention will now be described with reference to FIG. 14. In addition to the structure of the sixth embodiment, a cushion 21 parallel to the short sides of the lower substrate W2 is arranged in the central portion of the lower substrate W2.

When laminating the substrates W1 and W2, the cushions 21 function as projections that press the main seals 13 at the central portion of the lower substrate W2 and the dummy seal 14. This ensures the bonding of the dummy seal 14 and the main seals 13 to the substrates W1 and W2 and reduces deficient lamination.

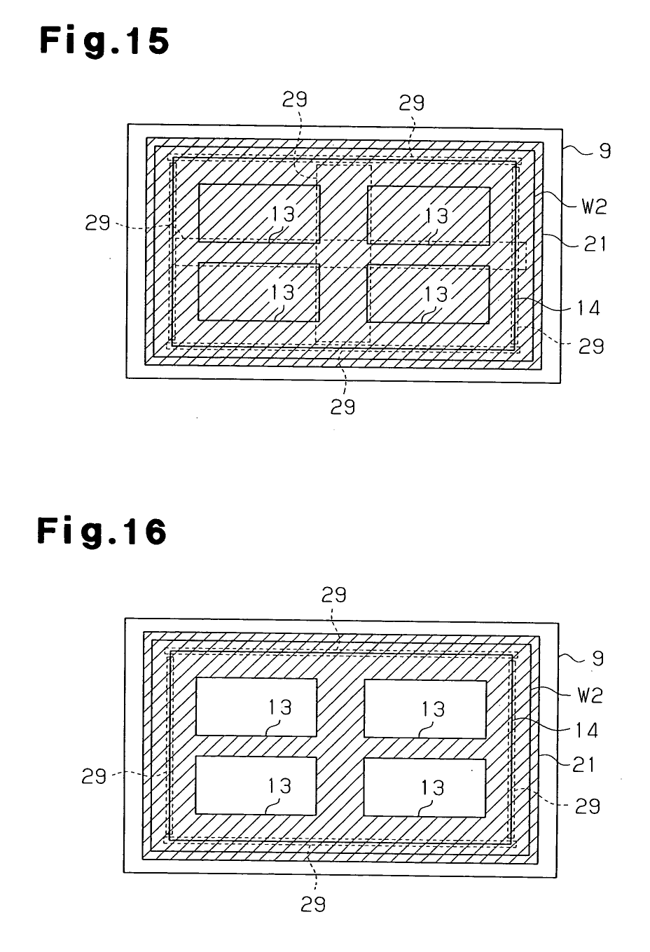

An eighth embodiment of the present invention will now be described with reference to FIG. 15. In the eighth embodiment, a cushion 21 is arranged between the lower holding plate 9 and the lower substrate W2 along the entire surface of the lower substrate W2. Further, tapes 29 are arranged on the upper surface of the lower holding plate 9 at portions corresponding to the dummy seal 14, the longitudinally central portion of the lower substrate W9, and the laterally central portion of the lower substrate W9.

The tapes 29 function as projections that press the main seals 13 and the dummy seal 14 at the central portion of the lower substrate W2. This ensures the bonding of the dummy seal 14 and the main seals 13 to the substrates W1 and W2 and reduces deficient lamination.

A ninth embodiment of the present invention will now be described with reference to FIG. 16. The ninth embodiment differs from the eighth embodiment in that tapes 29 are arranged on the lower holding plate 9 only at portions corresponding to the dummy seal 14 and in that the cushion 21 is eliminated from portions corresponding to the inner side of the main seals 13. Otherwise, the structure of the ninth embodiment is the same as that of the eighth embodiment. The tapes 29 function as projections that press the dummy seal 14.

It should be apparent to those skilled in the art that the present invention may be embodied in many other specific forms without departing from the spirit or scope of the invention. Particularly, it should be understood that the present invention may be embodied in the following forms.

Seal pressing devices may be provided for the upper holding plate 12.

Further, a seal pressing device may be provided in correspondence with the main seals.

In the eighth and ninth embodiments, the tapes 29 may be located between the lower holding plate 9 and the cushion 21 or between the cushion 21 and the lower substrate W2.

The present examples and embodiments are to be considered as illustrative and not restrictive, and the invention is not to be limited to the details given herein, but may be modified within the scope and equivalence of the appended claims.

1. An apparatus for manufacturing a laminated substrate by pressing two substrates towards each other, wherein one of the two substrates has a seal formed thereon, the apparatus comprising:
a processing chamber;
a first holding plate and a second holding plate arranged facing towards each other in the processing chamber to respectively hold one of the two substrates; and
a projection, arranged on at least one of the first and second holding plates at a portion corresponding to the seal, for pressing the seal.

2. The apparatus according to claim 1, wherein the projection includes a seal pressing device for pressing the substrates when the seal pressing device is supplied with gas.

3. The apparatus according to claim 1, wherein the seal pressing device includes:
a gas supply passage formed in one of the first and second holding plates and having an opening in a surface of the one of the first and second holding plates that faces towards the other one of the first and second holding plates, the gas supply passage being selectively supplied with gas; and
a sheet for covering the opening of the gas supply passage on the one of the first and second holding plates, the sheet deforming and pressing the substrates when the gas supply passage is supplied with gas.

4. The apparatus according to claim 3, wherein one of the first and second holding plates includes a recess, the recess accommodating the sheet so that the sheet does not contact the substrates when the gas supply passage is not supplied with gas.

5. The apparatus according to claim 3, wherein the sheet is made of a material having a friction coefficient greater than that of the material of the first and second holding plates.

6. The apparatus according to claim 3, wherein the sheet is one of a plurality of sheets arranged in accordance with different substrate sizes.

7. The apparatus according to claim 3, wherein the sheet is one of a plurality of sheets arranged along the seal.

8. The apparatus according to claim 3, wherein the gas supply passage is one of a plurality of equally spaced gas supply passages that are arranged along the seal, and the sheet is one of a plurality of equally spaced sheets that are adhered to one of the first and second holding plates to respectively cover the openings of the gas supply passages, each of the sheets being elastically expanded when the associated one of the gas supply passages is supplied with gas.

9. The apparatus according to claim 1, wherein the projection is a tape adhered to one of the first and second holding plates.

10. The apparatus according to claim 1, further comprising:
a cushion arranged between the projection and the substrates.

11. The apparatus according to claim 1, wherein the seal includes a main seal and a dummy seal surrounding the main seal, with the projection arranged at a position corresponding to the dummy seal.

12. The apparatus according to claim 11, wherein the main seal is one of a plurality of main seals formed on one of the two substrates, and the dummy seal is formed to surround the plurality of main seals.

13. A method for manufacturing a laminated substrate, the method comprising:
forming a seal on the lower substrate;
dropping liquid crystal into an inner region of the seal;
holding an upper substrate and the lower substrate with an upper holding plate and a lower holding plate facing towards each other in a processing chamber; and
pressing the upper substrate and the lower substrate between the upper holding plate and the lower holding plate, said pressing including:
pre-pressing a portion of the lower substrate that corresponds to the seal with gas pressure; and
pressing the upper substrate and the lower substrate with the upper holding plate and the lower holding plate subsequent to said pre-pressing.

14. The method according to claim 13, wherein said pre-pressing includes transmitting the gas pressure to the lower substrate via an elastic member.

15. The method according to claim 13, wherein said forming a seal includes:
forming a plurality of main seals on one of the two substrates; and
forming a dummy seal surrounding the main seals on the lower substrate,
and wherein said pre-pressing includes pressing a portion of the lower substrate that corresponds to the dummy seal.

16. An apparatus for manufacturing a laminated substrate from two substrates that are adhered to each other by a seal, the apparatus comprising:
a processing chamber;
a first holding plate and a second holding plate arranged facing towards each other in the processing chamber to press the two substrates that are adhered to each other by a seal; and
a seal pressing device, arranged on at least one of the first and second holding plates, for pressing the seal.

17. The apparatus according to claim 16, wherein the first holding plate is an upper holding plate for holding the upper substrate, the second holding plate is a lower holding pate for holding a lower substrate, and the seal pressing device is arranged on the lower holding plate.

18. The apparatus according to claim 16, wherein the seal pressing device includes:
a gas supply passage formed in one of the first and second holding plates and having an opening in a surface of the one of the first and second holding plates that faces towards the other one of the first and second holding plates, the gas supply passage being selectively supplied with gas; and
a sheet for covering the opening of the gas supply passage in the one of the first and second holding plates, the sheet deforming and pressing the substrates when the gas supply passage is supplied with gas.

19. The apparatus according to claim 18, wherein one of the first and second holding plates includes a recess, the recess accommodating the sheet so that the sheet does not contact the substrates when the gas supply passage is not supplied with gas.

20. The apparatus according to claim 16, wherein the seal is a dummy seal formed surrounding a plurality of main seals that are formed on one of the two substrates, and wherein the sheet presses a portion of said one of the two substrates that corresponds to the dummy seal.
